(19) United States
(12) Patent Application Publication
(10) Pub. No.: US 2024/0106269 A1
(43) Pub. Date: Mar. 28, 2024

(54) Method of Unlimited Direct Use Of Excess Energy, Generated During Off-Peak Consumption Of The Electrical Network

(71) Applicants: Peter Kaminsky, Thornhill (CA); Merilin Kernitzman, Thornhill (CA); Taly Kernitzman, Maple (CA)

(72) Inventors: Peter Kaminsky, Thornhill (CA); Merilin Kernitzman, Thornhill (CA); Taly Kernitzman, Maple (CA)

(21) Appl. No.: 18/364,453

(22) Filed: Aug. 2, 2023

(51) Int. Cl. H02J 15/00; H02J 3/28

(52) U.S. Cl. CPC H02J 15/008; H02J 3/28; H02J 15/003; H02J 2310/18

(57) ABSTRACT

The above patent application describes a method for the direct unlimited use of excess electricity that occurs during periods of decline in consumption of the electrical network. Until now, excess electricity is used on a limited scale by its preliminary accumulation and storage, until a period of growth in electricity consumption begins. The proposed method includes the conversion of excess electricity directly, in unlimited volumes, into other types of energy, for example, into thermal energy or into the chemical energy of artificially produced hydrogen. Further, the converted energy enters directly, without the need for accumulation and storage, into the furnaces of boilers, gas turbines, or other heat-power equipment, partially or completely replacing the main fuel. This method allows savings of at least 250 billion US dollars annually in the USA and Canada alone. On a global scale, the annual savings will be at least $1.5 trillion.

### CROSSREFERENCE TO RELATED APPLICATIONS

The proposed invention relates to the methods of the direct use of surplus electricity in an electrical network. This occurs during off-peak periods in consumer load (nights, weekends and holidays), which exceeds 50% of the total usage time. During these periods, thermal and nuclear power plants operate in a continuous (basic) mode. However, wind power plants (WPPs), solar and tidal power plants, and some other sources of electricity operate in a variable mode, depending on the wind speed, solar radiation intensity, and time of day, etc. The excess electricity generated by these sources during periods of consumer load decline is a very complex technical problem, which has not yet had an effective and economical solution.

There are various methods of energy accumulation and storage during periods of consumer load decline, and subsequent use of this energy during periods of increased electricity consumption. Currently, there are several types of electrical energy storage technologies: pumped storage power plants, chemical sources of electricity, systems based on electrochemical batteries, systems based on condensers, hydrogen production and storage technology, and others. All known methods of electricity accumulation during periods of load decline in the electrical network and its storage for later use during periods of increased electricity consumption requires significant capital investment. In addition, the total losses in the processes of energy storage and its subsequent use can be more than 50%. Therefore, these methods are currently of limited use.

### BACKGROUND OF THE INVENTION

Ways of direct use of excess electricity, avoiding the need for its accumulation and storage, include heating water and air in various rooms, air conditioning, irrigation of agricultural land, and others. These methods are also of limited use for large amount of surplus energy. As a result, during periods of load decline, more than half of the equipment that produces excess electricity is disconnected from consumers, meaning that the equipment is idle. In connection with the accelerated construction of high-capacity wind turbines, this problem is becoming even more severe.

### SUMMARY OF THE INVENTION

We propose a relatively simple, cost-effective, and highly energy-efficient method that allows unlimited direct use of the excess electricity generated by various power plants.

The following describes the proposed method. Special equipment is installed on thermal power plants (TPPs) as well as chemical, oil refining, metallurgical, cement, and other manufacturing facilities connected to the unified energy system. This special equipment is comprised of electrical heaters of water and/or air, refrigeration machines (RM), operating in the heat pump mode and allowing to effectively heat water or air, and equipment for the production of hydrogen from water by electrolysis. Using this equipment, excess electricity that occurs during periods of decline in consumer load in the electrical network is converted into thermal, chemical, and other types of energy. The converted energy, in the form of preheated water or air, as well as in the form of artificially produced hydrogen, is supplied directly to the thermal power equipment (boilers, gas turbines, and furnaces) of the above manufacturing facilities connected to the unified energy system. This makes it possible to eliminate the need for accumulation and storage of excess energy, as well as significantly reduce fuel consumption in boiler units and gas turbine units (GTU) of thermal power plants and in various thermal power equipment used in manufacturing facilities.

Below are three examples that illustrate the use of excess electricity using our proposed method.

### EXAMPLE 1

Powerful electrical heaters of water and/or air are installed in TPPs and other previously mentioned manufacturing facilities connected to the unified energy system.

It is known that the temperature of the water entering the combustion devices of boiler units is approximately 30 degrees Celsius. Further, due to the combustion of fuel in the combustion chambers, water is heated to the boiling point (at a water pressure of 100 atmospheres, the boiling point is 309 degrees), vaporization and steam overheating to the required temperature (usually 540-560 degrees) before steam is supplied to the turbine blades. If the water is preheated in electrical water heaters prior to supplying the water to the boilers, we will obtain significant savings in the fuel burned in the boiler's furnaces. When the water is preheated to 80 degrees, the fuel savings will be about 10%, when it is preheated to 130 degrees, the savings will reach 20%, and if the water is preheated to 180 degrees, the fuel savings will reach 30%. Note that the preheating of the water will not impact the maintenance of the necessary steam parameters before it is supplied to the turbine blades. By reducing the fuel supply to the combustion chambers of boiler units and gas turbines, the automatic control system will continuously maintain these parameters and the generated power at a given level.

Preheating of air before it is fed into the combustion chambers of boilers and gas turbines will also have a significantly reduce fuel consumption.

During the typical manufacturing processes of almost all of the above manufacturing facilities, hot water and hot air are constantly used. Therefore, preliminary heating of water and air before they are fed into furnaces, combustion chambers, furnaces, dryers, and other heat and power equipment used in these manufacturing facilities will result in a similar effect to that obtained at TPPs.

According to our calculations, at today's fuel prices, the total investment for the purchase and installation of the necessary additional equipment, will be paid off in four to six months.

### EXAMPLE 2

As described in the first example, excess electricity is used to preheat water and air before they are fed into heat power equipment. The difference lies in the fact that, in order to reduce the cost of electricity for heating water and air and increase the energy efficiency of thermal processes, the above-mentioned manufacturing facilities connected to the unified energy grid are equipped with powerful refrigeration machines (RM) that operate in the heat pump mode.

In a heat pump, a significant part of the energy needed to heat water and air comes from the environment (water from nearby rivers and reservoirs, or from atmospheric air). As a result, the consumption of electricity for heating water or air is reduced by two to three times, which allows to significantly increase the preliminary heating of water and air and get more significant fuel savings in thermal power plants, compared with the use of conventional electric water and air heaters. Therefore, although the cost of additional equipment will be higher, the payback period for these costs will not be more than six months.

### EXAMPLE 3

Equipment to produce hydrogen from water by electrolysis is installed in the above manufacturing facilities connected to the unified energy system. Produced hydrogen can be directly supplied to the burners of boilers, gas turbines, various furnaces, dryers and other heat power plants to partially or completely replace the fuel they use. To do this, the above equipment must be equipped with devices that enable parallel safe operation of hydrogen (similar to how in various countries, gasoline-powered vehicles were easily converted to run on gas fuel). The automatic control system ensures the supply of the missing amount of the main fuel maintains the required parameters of the heat power equipment. Thus, both for powerful consumers and for consumers of small to medium power, there is no need for a large number of expensive hydrogen storage systems.

### CONCLUSIONS

Hydrogen produced by the surplus nearly free electricity and taking into account the significantly higher specific calorific value of hydrogen, at today's prices for hydrocarbon fuel, is equivalent to three to four times cheaper than natural gas. Therefore, it is economically advantageous to use as much surplus electricity as possible to produce hydrogen supplied directly to the combustion chambers of both large and small consumers.

Savings in monetary terms will amount to at least $0.05 for each generated kilowatt-hour of electricity or $200 per year for one installed kilowatt of power. The complete transfer of all consumers of gas and fuel oil to hydrogen fuel according to the method proposed will save more than $250 billion annually in the USA and Canada alone. On a global scale, the savings will be at least $1.5 trillions dollars a year.

In addition to the economic benefits, the transfer of thermal power plants, gas turbines and other consumers to hydrogen fuel will significantly improve the environmental situation, due to the fact that when hydrogen is burned, only harmless water vapor is formed and carbon dioxide is not formed, which enhances the greenhouse effect and avoids Earth warming, ice melting in Greenland, the Arctic and Antarctic, and other undesirable consequences.

1. A method of direct use of excess electricity that occurs in the electrical network during periods of consumer load decline, is novel since in order to convert excess electricity of unlimited capacity into thermal, chemical or other types of energy, on the territory of manufacturing facilities connected to the unified energy system (TPP, metallurgical, chemical, oil refineries, cement and other plants), special equipment is installed (electric water and air heaters, RM, operating in the heat pump mode, plants for producing hydrogen from water by electrolysis, etc.), designed to convert excess electricity into thermal, chemical or other energy types.

2. In addition to the first claim, this method is novel since in order to eliminate the cost of accumulating and storing converted energy, as well as to reduce fuel consumption in thermal power equipment (boilers, gas turbines, furnaces, and dryers) of the previously mentioned manufacturing facilities, water and air used in the operation cycles of heat power equipment, is preheated using excess electricity before entering the heat power equipment. This is accomplished by either using electrical water and air heaters or with the help of refrigerating machines (RM) operating in the heat pump mode, which they enter directly into the above heat power equipment immediately after heating (examples 1 and 2).

3. In addition to the first claim, is novel since in order to significantly reduce the cost of fuel used by thermal power plants, using excess electricity, hydrogen is obtained from water by electrolysis in the plants installed on the above-mentioned manufacturing facilities and fed directly to the burners of boiler units, gas turbines, and furnaces, partially or completely replacing the main fuel used in these thermal power plants.
